(19) United States
(12) Patent Application Publication
(10) Pub. No.: US 2014/0093612 A1
(43) Pub. Date: Apr. 3, 2014

(54) METHOD FOR OBTAINING A FERMENTED DAIRY PRODUCT

(71) Applicants: Agusti Montserrat Carreras, Barcelona (ES); María Lavilla Martin, Erandio (ES); Iñigo Martinez De Marañón Ibabe, Bilbao (ES); Juan Carlos Arboleya Payo, Bilbao (ES); Francesc Bové Bonet, Barcelona (ES)

(72) Inventors: Agusti Montserrat Carreras, Barcelona (ES); María Lavilla Martin, Erandio (ES); Iñigo Martinez De Marañón Ibabe, Bilbao (ES); Juan Carlos Arboleya Payo, Bilbao (ES); Francesc Bové Bonet, Barcelona (ES)

(73) Assignee: DANONE, S.A., Barcelona (ES)

(21) Appl. No.: 14/111,342

(22) PCT Filed: Apr. 12, 2011
(86) PCT No.: PCT/EP2011/055711

§ 371 Date: Dec. 12, 2013

(51) Int. Cl. A23C 9/123

(52) U.S. Cl. CPC A23C 9/1238
USPC 426/43; 426/583

(57) ABSTRACT

The invention defines a method for obtaining a fermented dairy product characterized by a heat treatment step followed or preceded by a high pressure homogenization step at a pressure above 100 MPa and up to 350 MPa of a dairy starting material, wherein the total fat composition of the dairy starting material lies between 0.05% and 10% by weight, wherein the total quantity of protein lies between 3 and 10% by weight, and wherein the fat and protein come exclusively from the dairy starting material. This method allows obtaining fermented dairy products with improved rheological properties avoiding the use of additives such as thickeners or stabilizers. Also, it allows obtaining fermented dairy products with improved mouth-feel.

### FIELD OF THE INVENTION

The invention relates to food products and to their methods of preparation. More particularly, the invention relates to fermented dairy products and to their methods of preparation. The invention further relates to a process for the preparation of additive-free set, stirred or drinkable yogurts with improved texture.

### BACKGROUND OF THE INVENTION

A conventional yogurt manufacturing process includes a thermal treatment (pasteurization) and a conventional homogenization at low pressures (usually at 150-200 bar) of milk previously to its fermentation by starters. After pasteurization, milk is cooled at warm temperatures (about 40° C.) for the inoculation of the desired starters. Fermentation by lactic acid bacteria takes place in the final packaging or fermentation tanks so, as the product ferments, pH of milk decreases. Finally the product is cooled and its viscosity increases to its final viscosity values. The texture and characteristics of the obtained product is a combination of the initial milk composition, the modification of milk components by thermal treatment and homogenization and the culture action, and a wide variety of thickeners and stabilizers that can be also used to supplement the cultured fermented milk characteristics.

During the last years, the application of high pressure homogenization (HPH) and ultra high pressure homogenization (UHPH) has been studied in the dairy product manufacturing as an alternative to pasteurization of milk, as this technology can reduce the microorganisms load in milk.

In general, during HPH, homogenization is obtained by forcing a product through a small orifice between the homogenizing valve and the valve seat, which generates high velocity microstreams as a fluid accelerates into a specifically designed interaction chamber, generating different mechanisms, including turbulence, high shear, cavitation and impact forces that cause the formation of fine emulsions of milk fat.

The major parameters determining efficiency of HPH are operating pressure, number of passes through the valve, temperature, and homogenizer valve design while the scale of operation does not appear to influence the extent of homogenization. It is hence understandable that the main differences between homogenizers from different manufacturers are in the homogenizer valves.

High pressure homogenization (HPH) differs from high hydrostatic pressure (HHP) which consists in applying a static high pressure to the product for a relatively long period of time (usually several minutes).

The patent application EP 1464230 A1 describes a process to improve the texture of dairy products containing 2-10% fat using a conventional homogenizer wherein globules are projected on a valve seat, working at a pressure over 400 bar previously to a heat treatment of pasteurization. The most interesting pressure used to reach the improved texture is between 500 and 1000 bar. An homogenization at 1800 bar is also mentioned that can cause an increase in viscosity of about 25% compared to conventional pressure homogenization (200 bar). However, this document concludes that homogenization at pressures above 1000 bar leads to little changes in terms of viscosity, fat globule size and the presence of high-size fat globules, while a viable industrial application is difficult to be achieved using these high pressure levels.

The patent application EP 1980154 A1 illustrates a process for obtaining fine textured dairy products such as a cream cheese, by acidifying with citric acid, optionally heating and homogenizing a milk protein concentrate in a single or two-step homogenization process at pressures of 600 bar, 630/130 bar or 800/160 bar, to reduce the size of protein aggregates and avoid the re-aggregation. The milk protein concentrate used as a substrate in the process typically comprises 5% or more of protein in total (the protein content may be in the range of 5-20%). The fat content in the milk protein concentrate used as a substrate in the process may be in the range of 0.2-10% by weight in total. The dairy product obtained has a mean protein particle size between 1 and 15 μm.

Several authors have tested the combination of thermal treatment (TT) and high pressure homogenization (HPH) as a way to test effects on milk gelification and yogurt production. However, viewing the results from these studies, no definitive and clear conclusions have been found about the effect of a combined treatment:

Herńandez and Harte (2008) checked different combinations of a Thermal Treatment at 90° C. (TT) and High Pressure Homogenization (HPH) in the manufacture of acid gels (acidified by the addition of glucono-δ-lactone) from milk. They found only a small increase in viscosity of gels, from a G′ of 260 Pa for TT milk, to a maximum G′ of 320 Pa for TT-HPH (combination of thermal treatment with one-step homogenization at a pressure of 350 MPa), which represents an increase on viscosity of −23% (similar to EP 1464230). Additionally, no effect of combined treatment (TT-HPH) was found in water holding capacity of products when compared to TT alone.

Oppositely to the results obtained by Hernandez and Harte, mentioned above, recently Ciron et al. (2010), working with reconstituted milk heat-treated and homogenized at 150 MPa in one-stage process, conclude that the combined treatment, depending on the fat content of the milk, had no effect (for 1.5% fat products), or even a negative effect (for non-fat products) on the texture profile of yogurts.

However, surprisingly, with the complete combined process developed and described in this invention, whose parameters have been clearly defined in order to obtain optimal results in obtained yogurts, a high and palpable improvement in the final characteristics of fermented products (up to 73% more viscosity −G″—in skimmed products and 82% more viscosity −G″—in full fat yogurts) has been obtained, even more than a high pressure homogenization alone. Moreover, the described process, using a high pressure homogenizer, is feasible technological-industrial application.

Also, the method of the invention allows obtaining fermented dairy products with improved rheological properties avoiding the use of additives such as thickeners or stabilizers. In fact, the skimmed yogurt obtained by the method of the invention shows a better texture more homogeneous, viscous, dense and creamy, and a more intense (but pleasant) dairy flavour than conventional skimmed yogurts. Likewise the full-fat yogurt obtained by the method of the invention has a texture similar to that of “Greek yogurt” but with a lower content of fat but without the need of using of texturizants, stabilizers, binders, gelling and/or thickener additives.

### OBJECT OF THE INVENTION

Therefore an object of the present invention is to provide a method for obtaining a fermented dairy product.

Another object of the invention is the fermented dairy product obtainable by said method.

### DESCRIPTION OF THE FIGURES

FIG. 1a is a flow chart showing a particular embodiment of the method of the invention, with high pressure homogenization being performed while temperature after pasteurization is falling.

FIG. 1b is a flow chart showing a particular embodiment of the method of the invention, with high pressure homogenizing being performed while temperature is rising before pasteurization.

FIG. 2 shows the distribution of milk fat globules after a pasteurization and standard homogenization method (2a) and after the method of the invention with the homogenization step performed at 150 MPa (2b) and 300 MPa (2c).

FIG. 3 shows the surface tension of milk proteins after a high pressure homogenization method at 300 MPa (T1), after a pasteurization and conventional homogenization method at 15 MPa (T2) and after the method of the invention (pasteurization and high pressure homogenization at 300 MPa) (T3).

FIG. 4 shows the evolution of the elasticity (G′) during fermentation step after a high pressure homogenization method at 300 MPa (T1), after a pasteurization and conventional homogenization method at 15 MPa (T2) and after the method of the invention (pasteurization and high pressure homogenization at 300 MPa) (T3).

FIG. 5 shows the flocculation measurements during fermentation step after a high pressure homogenization method at 300 MPa (T1), after a pasteurization and conventional homogenization method at 15 MPa (T2) and after the method of the invention (pasteurization and high pressure homogenization at 300 MPa) (T3).

FIG. 6a shows the curves of viscosity (G″) and elasticity (G′) of a set full-fat yogurt obtained after a high pressure homogenization method at 300 MPa (T1), after a pasteurization and conventional homogenization method at 15 MPa (T2) and after the method of the invention (pasteurization and high pressure homogenization at 300 MPa) (T3).

FIG. 6b shows the curves of viscosity (G″) and elasticity (G′) of a stirred full-fat yogurt obtained after a high pressure homogenization method at 300 MPa (T1), after a pasteurization and conventional homogenization method at 15 MPa (T2) and after the method of the invention (pasteurization and high pressure homogenization at 300 MPa) (T3).

FIG. 7a shows the curves of viscosity (G″) and elasticity (G′) of a set skimmed yogurt obtained after a high pressure homogenization method at 300 MPa (T1), after a pasteurization and conventional homogenization method at 15 MPa (T2) and after the method of the invention (pasteurization and high pressure homogenization at 300 MPa) (T3).

FIG. 7b shows the curves of viscosity (G″) and elasticity (G′) of a stirred skimmed yogurt obtained after a high pressure homogenization method at 300 MPa (T1), after a pasteurization and conventional homogenization method at 15 MPa (T2) and after the method of the invention (pasteurization and high pressure homogenization at 300 MPa) (T3).

FIG. 8a represents two embodiments of dead-end chambers allowing reverse stream of the dairy material so as to achieve collision between the material particles.

FIG. 8b represents a chamber embodiment where at least two nozzles project the dairy material in opposite direction in order to obtain the collision of the particles.

### DETAILED DESCRIPTION OF THE INVENTION

The present invention provides a method for obtaining a fermented dairy product (thereafter “the method of the invention”) wherein a heat treatment step is carried out followed or preceded by a high pressure homogenization step at a pressure above 100 MPa and up to 350 MPa of a dairy starting material, wherein the total fat composition of the dairy starting material lies between 0.05% and 10% by weight, wherein the total quantity of protein lies between 3 and 10% by weight, and wherein the fat and protein come exclusively from the dairy starting material.

In a preferred embodiment the fermented milk product substantially does not comprise fat-containing and/or protein-containing additives, such as additives added after the homogenization step.

In the context of the invention the expression “dairy starting material” refers to milk, a milk derivative or mixtures thereof. Also, the expression “the fat and protein come exclusively from the dairy starting material” refers to the fact that fat and protein of the final fermented dairy product can not come from a starting material other than the above-mentioned dairy starting material. Nonetheless other components other than the dairy starting material can be optionally used such as natural or artificial sweeteners, flavours, fruits, cereals, etc. . . .

In a particular embodiment of the method of the invention, the milk is selected from raw milk, skimmed milk, semi-skimmed milk, fat-enriched milk, and mixtures thereof. In other particular embodiment of the method of the invention, the milk derivative is selected from milk powder, skimmed milk powder, milk proteins, milk protein concentrate, concentrated milk, evaporated milk, milk cream, and mixtures thereof.

In a preferred embodiment of the method of the invention, the dairy starting material consists of a mixture of raw milk and skimmed milk powder. In other preferred embodiment of the method of the invention, the dairy starting material consists of a mixture of skimmed milk and skimmed milk powder. The dairy starting material to be used in the method of the invention can derive from any milk such as cow's milk, sheep's milk, goat's milk, etc. In a preferred embodiment of the method of the invention, the dairy starting material comes from cow's milk.

In the context of the invention the expressions “fermented dairy product”, “cultured milk product” and “cultured dairy product” are interchangeable and relate to a product obtained from a mixture of milk and a milk derivative, and acidified by fermentation with selected microorganisms in order to obtained desired product characteristics.

Also, in the context of the invention the expressions “skimmed product” and “low-fat product” are equivalent and relate to a product with a total content of fats in the range of 0.05-2% by weight.

Moreover, in the context of the invention the expressions “full-fat product”, “whole-fat product” and “unskimmed product” are interchangeable and relate to a product with a total content of fats in the range of 3-5% by weight.

In a particular and preferred embodiment of the method the high pressure homogenization is preceded by the heat treatment step. This embodiment can lead to viscosity and/or texture improvement.

In a particular embodiment of the invention the heat treatment is performed at a temperature of 40-99° C., preferably 72-99° C., for example for 2-10 minutes.

In a particular embodiment the material is cooled down at a temperature of 40-98° C. after the heat treatment.

In a particular embodiment of the invention the fat content of the dairy staring material is of from 0.05% to 0.1% or from 0.1% to 0.5%, or from 0.5% to 1%, or from 1% to less than 2%, or from 2% to 3%, or from 3% to 5% or from 5% to 10%.

In a particular embodiment the protein content of the dairy staring material is of 3% or of from more than 3% to less 4% or of 4%, or of from more than 4% to less than 5%, or of 5%, or of from more than 5% to 6%, or of from 6% to 7%, or of from 7% to 8% or of from 8% to 9%, or of from 9% to 10%.

In a particular embodiment of the method of the invention, a heat treatment step is carried out followed or preceded by a high pressure homogenization step at a pressure above 130 MPa and up to 330 MPa of a dairy starting material, wherein the total fat composition of the dairy starting material lies between 0.05% and 10% by weight, wherein the total quantity of protein lies between 3 and 10% by weight, and wherein the fat and protein come exclusively from the dairy starting material.

In a particular embodiment of the method of the invention, a heat treatment step is carried out followed or preceded by a high pressure homogenization step at a pressure above 200 MPa and up to 310 MPa of a dairy starting material, wherein the total fat composition of the dairy starting material lies between 0.05% and 10% by weight, wherein the total quantity of protein lies between 3 and 10% by weight, and wherein the fat and protein come exclusively from the dairy starting material.

In other particular embodiment of the method of the invention, a heat treatment step is carried out followed or preceded by a high pressure homogenization step at a pressure above 200 MPa and up to 350 MPa of a dairy starting material, wherein the total fat composition of the dairy starting material lies between 0.05% and 10% by weight, wherein the total quantity of protein lies between 3 and 10% by weight, and wherein the fat and protein come exclusively from the dairy starting material.

In a preferred embodiment of the method of the invention, a heat treatment step is carried out followed or preceded by a high pressure homogenization step at a pressure above 230 MPa and up to 330 MPa of a dairy starting material, wherein the total fat composition of the dairy starting material lies between 0.05% and 10% by weight, wherein the total quantity of protein lies between 3 and 10% by weight, and wherein the fat and protein come exclusively from the dairy starting material.

In a preferred embodiment of the method of the invention, a heat treatment step is carried out followed or preceded by a high pressure homogenization step at a pressure above 250 MPa and up to 310 MPa of a dairy starting material, wherein the total fat composition of the dairy starting material lies between 0.05% and 10% by weight, wherein the total quantity of protein lies between 3 and 10% by weight, and wherein the fat and protein come exclusively from the dairy starting material.

In a most preferred embodiment of the method of the invention, a heat treatment step is carried out followed or preceded by a high pressure homogenization step at a pressure of 300 MPa of a dairy starting material, wherein the total fat composition of the dairy starting material lies between 0.05% and 10% by weight, wherein the total quantity of protein lies between 3 and 10% by weight, and wherein the fat and protein come exclusively from the dairy starting material.

The high pressure homogenization step is typically performed in an equipment appropriate for withstanding such high pressures. The material of the equipment can be selected accordingly by the skilled in the art.

Preferably the homogenization step is performed by passing a stream of material in a chamber via at least one nozzle. It has been observed that by a specific chamber design and the nozzle(s) arrangement, improved results are obtained in the homogenization step. More specifically it has been observed that if chamber design and nozzle(s) are arranged such that there are streams of dairy material in opposite directions an improved homogenization is achieved. Said improved homogenization results because particles from the dairy material flowing in opposite directions are subjected to collision, thereby allowing a size reduction improvement. The strong shear and shocks occurring in the chamber of high pressure homogenizers induce changes not only in fat globules but also in conformation of proteins.

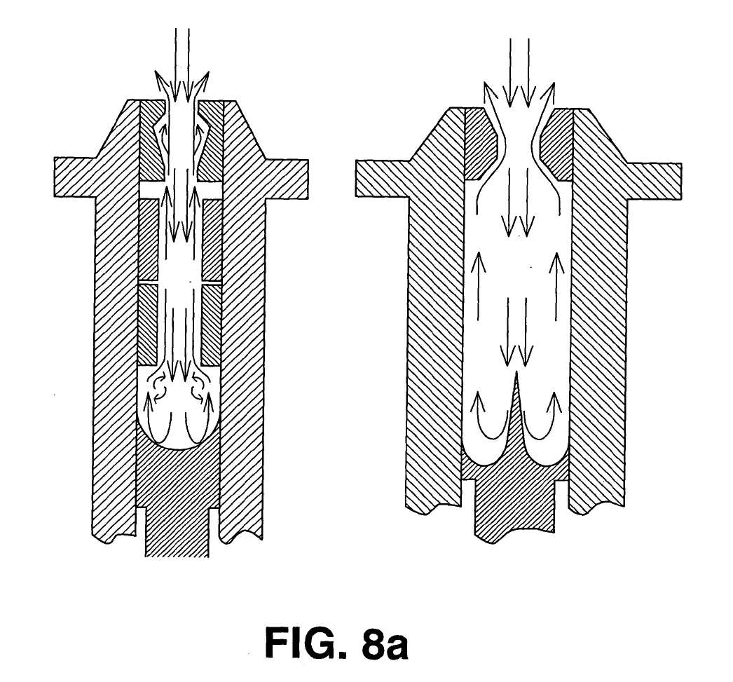

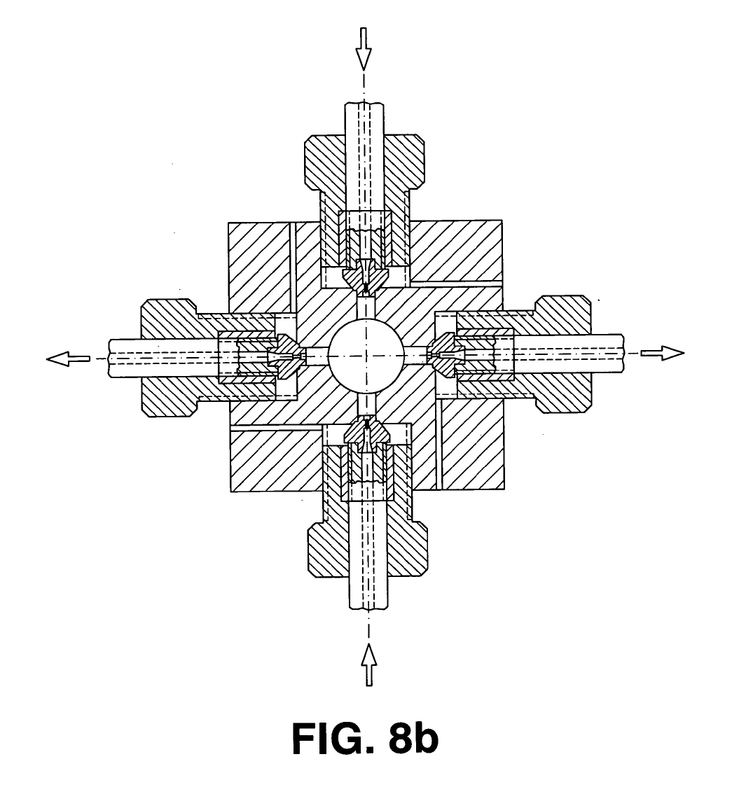

In one embodiment the opposite directions are obtained projecting material stream to a dead-end in the chamber and allowing at reverse stream on the periphery. Such an embodiment can be for example carried out with equipments marketed by BEE international. Reference is made for examples to document WO96/14141 (see also FIG. 8a).

In one embodiment the opposite directions are obtained by projecting material from at least two nozzles in opposite directions. Such an embodiment can be for example carried out with equipments marketed by Ekato. Reference is made for example to document US 2006/010973 (see also FIG. 8b).

Preferably the average particle size (defined and measured as mentioned in the examples) after the homogenization step is of less than 400 nm. Preferably the pressure, fat content, and/or homogenization equipment are set such that the average particle size (defined and measured as mentioned in the examples) after the homogenization step is of less than 400 nm. Processes allowing stream of material in opposite directions help in reducing the particles size and in changing the conformation of proteins.

The present inventors describe a complete and continuous technological (industrial) combined process to treat standardized milk, which improves the final characteristics of fermented dairy products.

Several combinations of the parameters are described:

A) A process according to the initial description comprising:
(a) preheating the dairy starting material to a first temperature of 72-99° C. and allowing to stand it at this temperature for 2-10 minutes;
(b) if necessary, cooling down the heated dairy starting material to achieve a temperature lower than 72-99° C. but in the range of 40-98° C. (in all cases, never less than 40° C., in order to avoid development of lipolysis and off-flavours);
(c) high-pressure-homogenizing the dairy starting material at the temperature of step 1) or optionally at the temperature of step 2) in a single step at a pressure between 100 MPa and 350 MPa; and
(d) cooling down of emulsion obtained to a temperature between 30 and 45° C. for addition of selected starters and further fermentation.
   B) A process according to the initial description comprising:
(v) preheating the dairy starting material to a first temperature of 40-99° C.;
(w) high-pressure-homogenizing the preheated dairy starting material in a single step at a pressure between 100 MPa and 350 MPa;
(x) allowing to stand the homogenized material at a temperature of 72-99° C. for 2-10 minutes;
(y) cooling down of emulsion obtained to achieve a temperature between 30 and 45°, for the addition of selected starters and further fermentation.

All the steps described, taken as a whole, are essential and crucial to obtain the desired results:

It is known that the major parameters determining efficiency of HPH treatment are operating pressure, number of passes through the homogenization valve and temperature:
It has been checked that with the combined treatment described in this invention, pressures below 100 MPa produce a reduction of fat globule size (avoiding creaming of fat during set yogurt fermentation) but did not cause significant changes in the texture of final product as obtained by pressures higher than 100 MPa specially at pressures over 130 MPa.
A two-steps high pressure homogenization (e.g. two passes at 130 MPa each), has been also checked, but this process in combination with previous heat treatment did not improve significantly the texture of obtained products.
These results confirm that the described new process should be the optimum, under the point of view of both organoleptic modifications and industrial implementation.

The ultra high pressure homogenizing step of the method of the present invention transforms the initial coarse milk emulsion into a finer emulsion of fats in water with a distribution of fat globule diameters always under 400 nm while in prior art method the homogenization provided fat globule distribution lying mainly between 0.4 and 1 μm. The general objective of this homogenization step is to create fat globules of smaller size to avoiding possible creaming of the fat during the subsequent fermenting step.

The applicants have observed that an important increase of viscosity can be achieved by subjecting the milk emulsion to a high pressure homogenizing operation combined with a heat treatment in both combinations, when the temperature is falling (process A) and when temperature is rising (process B).

Therefore, in a particular embodiment, the method of the invention comprises the steps of:
(a) heat treatment of a dairy starting material at a temperature of 72-99° C. for 2-10 minutes;
(b) optionally cooling down of the heated material obtained in (a) to a temperature lower that the temperature of (a) and in the range of 40-98° C.;
(c) high pressure homogenization of the material obtained in (a) or optionally in (b) in a single step at a pressure of 100-350 MPa to obtain a dairy emulsion;
(d) cooling down of the dairy emulsion obtained in (c) to a temperature of 30-45° C.; and
(e) fermentation of the cooled dairy emulsion obtained in step (d).

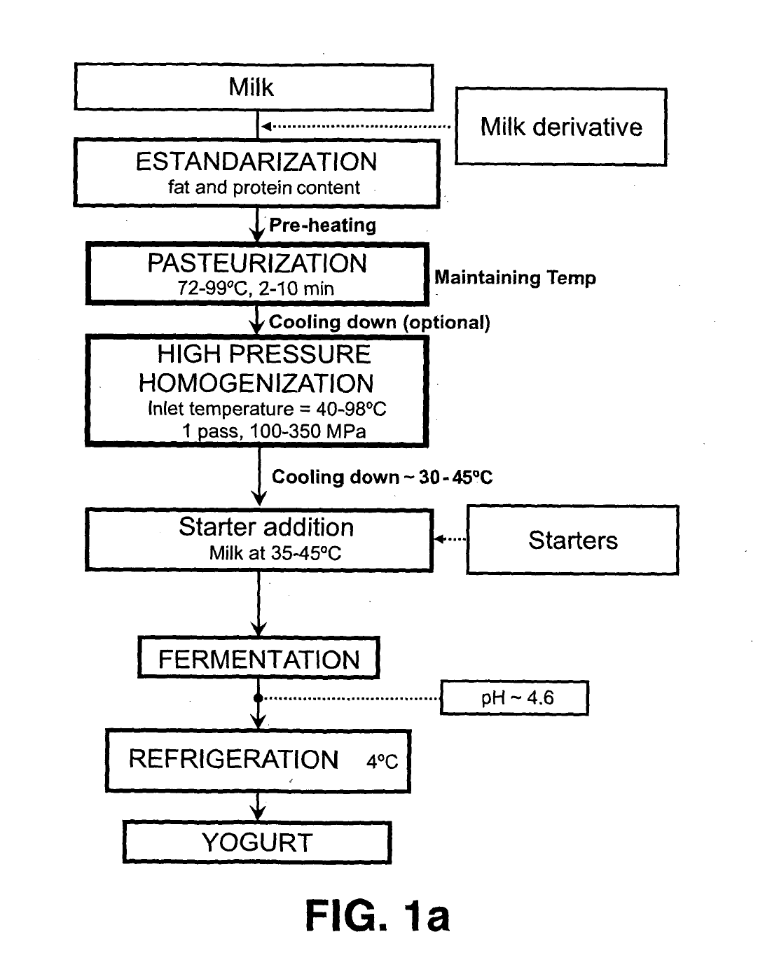

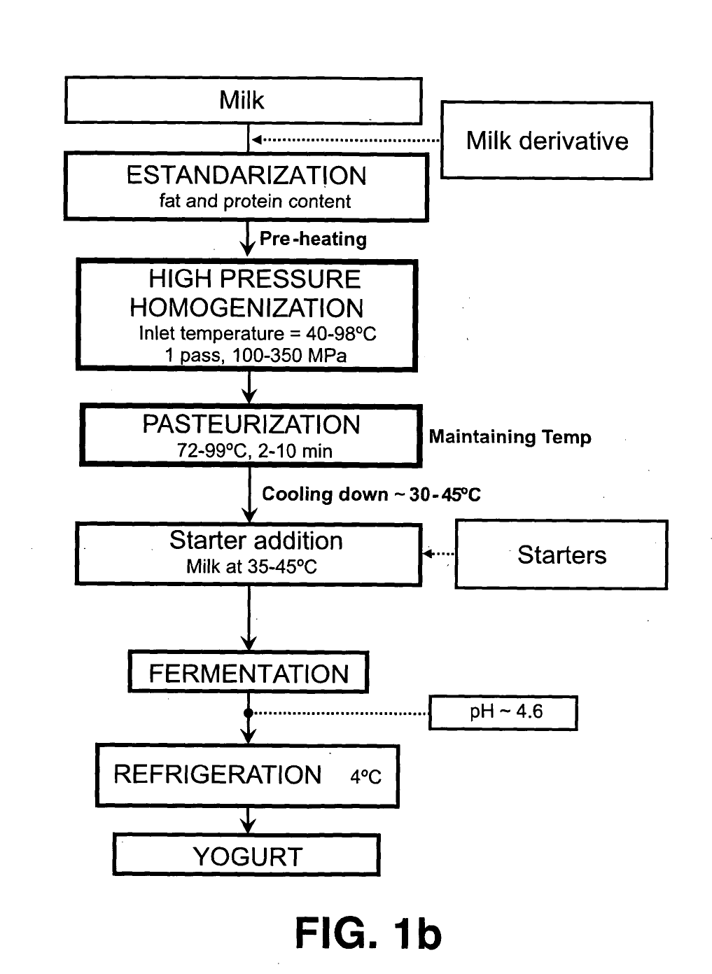

FIG. 1a is a flow-chart showing this particular embodiment of the method of the invention, with high pressure homogenization being performed while temperature after pasteurization is falling. The initial emulsion (dairy starting material and optionally other suitable components) is pasteurized at a temperature of 72-99° C. for 2-10 minutes. For homogenizing at a pressure of 100-350 MPa, the pasteurized emulsion can be cooled down previously to a temperature of 40-98° C. After homogenization, the milk is immediately pre-cooled at a temperature of 30-45° C. and subjected to fermentation.

The heat treatment of step (a) can be carried out in any suitable heating device of the art such as a batch or a tubular or a plate pasteurizer. Also, the cooling down of step (b) can be carried out in any suitable cooling device of the art. The high pressure homogenization of step (c) can be carried out in any suitable high pressure homogenizer, and more preferably in an homogenizer capable of subjecting streams of dairy material in opposite material such as the homogenizer described in WO96/14141 or that described in US 2006/010973.

In a preferred embodiment, the method of the invention comprises the steps of:
(a) heat treatment of a dairy starting material at a temperature of 72-99° C. for 2-10 minutes;
(b) cooling down of the heated material obtained in (a) to a temperature lower that the temperature of (a) and in the range of 40-98° C.;
(c) high pressure homogenization of the material obtained in (b) in a single step at a pressure of 130-330 MPa to obtain a dairy emulsion;
(d) cooling down of the dairy emulsion obtained in (c) to a temperature of 30-45° C.; and
(e) fermentation of the cooled dairy emulsion obtained in step (d).

In other preferred embodiment, the method of the invention comprises the steps of:
(a) heat treatment of a dairy starting material at a temperature of 72-99° C. for 2-10 minutes;
(b) cooling down of the heated material obtained in (a) to a temperature lower that the temperature of (a) and in the range of 40-98° C.;
(c) high pressure homogenization of the material obtained in (b) in a single step at a pressure of 200-310 MPa to obtain a dairy emulsion;
(d) cooling down of the dairy emulsion obtained in (c) to a temperature of 30-45° C.; and
(e) fermentation of the cooled dairy emulsion obtained in step (d).
(f)

In other preferred embodiment, the method of the invention comprises the steps of:
(a) heat treatment of a dairy starting material at a temperature of 72-99° C. for 2-10 minutes;
(b) cooling down of the heated material obtained in (a) to a temperature lower that the temperature of (a) and in the range of 40-98° C.;
(c) high pressure homogenization of the material obtained in (b) in a single step at a pressure of 200-350 MPa to obtain a dairy emulsion;
(d) cooling down of the dairy emulsion obtained in (c) to a temperature of 30-45° C.; and
(e) fermentation of the cooled dairy emulsion obtained in step (d).

In other preferred embodiment, the method of the invention comprises the steps of:
(a) heat treatment of a dairy starting material at a temperature of 72-99° C. for 2-10 minutes;
(b) cooling down of the heated material obtained in (a) to a temperature lower that the temperature of (a) and in the range of 40-98° C.;
(c) high pressure homogenization of the material obtained in (b) in a single step at a pressure of 230-330 MPa to obtain a dairy emulsion;
(d) cooling down of the dairy emulsion obtained in (c) to a temperature of 30-45° C.; and
(e) fermentation of the cooled dairy emulsion obtained in step (d).

In other preferred embodiment, the method of the invention comprises the steps of:
(a) heat treatment of a dairy starting material at a temperature of 72-99° C. for 2-10 minutes;
(b) cooling down of the heated material obtained in (a) to a temperature lower that the temperature of (a) and in the range of 40-98° C.;
(c) high pressure homogenization of the material obtained in (b) in a single step at a pressure of 250-310 MPa to obtain a dairy emulsion;
(d) cooling down of the dairy emulsion obtained in (c) to a temperature of 30-45° C.; and
(e) fermentation of the cooled dairy emulsion obtained in step (d).

In a preferred embodiment of the method of the invention, the heat treatment of step (a) is carried out at a temperature of 90° C.

In a preferred embodiment of the method of the invention, the heated material obtained in (a) is cooled to a temperature of 40° C. In other preferred embodiment of the method of the invention, the heated material obtained in (a) is cooled to a temperature of 80° C.

In a preferred embodiment of the method of the invention, the dairy emulsion obtained in (c) is cooled to a temperature of 40° C.

Therefore, in a most preferred embodiment, the method of the invention comprises the steps of:
(a) heat treatment of a dairy starting material at a temperature of 90° C. for 5 minutes;
(b) cooling down of the heated material obtained in (a) to a temperature of 40° C.;
(c) high pressure homogenization of the material obtained in (b) in a single step at a pressure of 300 MPa to obtain a dairy emulsion;
(d) cooling down of the dairy emulsion obtained in (c) to a temperature of 40° C.; and
(e) fermentation of the cooled dairy emulsion obtained in step (d).

In other most preferred embodiment, the method of the invention comprises the steps of:
(a) heat treatment of a dairy starting material at a temperature of 90° C. for 5 minutes;
(b) cooling down of the heated material obtained in (a) to a temperature of 80° C.;
(c) high pressure homogenization of the material obtained in (b) in a single step at a pressure of 300 MPa to obtain a dairy emulsion;
(d) cooling down of the dairy emulsion obtained in (c) to a temperature of 40° C.; and
(e) fermentation of the cooled dairy emulsion obtained in step (d).

In other particular embodiment, the method of the invention comprises the steps of:
(v) pre-heating the dairy starting material at a temperature of 40-99° C.;
(w) high pressure homogenization of the pre-heated material obtained in (v) in a single step at a pressure of 100-350 MPa;
(x) heat treatment of the dairy emulsion obtained in step (w) at a temperature of 72-99° C. for 2-10 min;
(y) cooling down of the dairy emulsion of (x) to a temperature of 30-45° C.; and
(z) fermentation of the cooled dairy emulsion obtained in step (y).

FIG. 1b is a flow chart showing this particular embodiment of the method of the invention, with high pressure homogenizing being performed while temperature is rising before pasteurization. The initial emulsion (dairy starting material and optionally other suitable components) is preheated at a temperature of 40-99° C. After homogenization at 100-350 MPa the emulsion is allowed to stand at a temperature of 72-99° C. for 2-10 minutes, and then it is immediately pre-cooled at a temperature of 30-45° C. and subjected to fermentation.

In other particular embodiment, the method of the invention comprises the steps of:
(v) pre-heating the dairy starting material at a temperature of 40-99° C.;
(w) high pressure homogenization of the pre-heated material obtained in (v) in a single step at a pressure of 130-330 MPa;
(x) heat treatment of the dairy emulsion obtained in step (w) at a temperature of 72-99° C. for 2-10 min;
(y) cooling down of the dairy emulsion of (x) to a temperature of 30-45° C.; and
(z) fermentation of the cooled dairy emulsion obtained in step (y).

In other particular embodiment, the method of the invention comprises the steps of:
(v) pre-heating the dairy starting material at a temperature of 40-99° C.;
(w) high pressure homogenization of the pre-heated material obtained in (v) in a single step at a pressure of 200-310 MPa;
(x) heat treatment of the dairy emulsion obtained in step (w) at a temperature of 72-99° C. for 2-10 min;
(y) cooling down of the dairy emulsion of (x) to a temperature of 30-45° C.; and
(z) fermentation of the cooled dairy emulsion obtained in step (y).

In other particular embodiment, the method of the invention comprises the steps of:
(v) pre-heating the dairy starting material at a temperature of 40-99° C.;
(w) high pressure homogenization of the pre-heated material obtained in (v) in a single step at a pressure of 200-350 MPa;
(x) heat treatment of the dairy emulsion obtained in step (w) at a temperature of 72-99° C. for 2-10 min;
(y) cooling down of the dairy emulsion of (x) to a temperature of 30-45° C.; and
(z) fermentation of the cooled dairy emulsion obtained in step (y).

In other particular embodiment, the method of the invention comprises the steps of:
(v) pre-heating the dairy starting material at a temperature of 40-99° C.;
(w) high pressure homogenization of the pre-heated material obtained in (v) in a single step at a pressure of 230-330 MPa;
(x) heat treatment of the dairy emulsion obtained in step (w) at a temperature of 72-99° C. for 2-10 min;
(y) cooling down of the dairy emulsion of (x) to a temperature of 30-45° C.; and
(z) fermentation of the cooled dairy emulsion obtained in step (y).

In other particular embodiment, the method of the invention comprises the steps of:
(v) pre-heating the dairy starting material at a temperature of 40-99° C.;
(w) high pressure homogenization of the pre-heated material obtained in (v) in a single step at a pressure of 250-310 MPa;
(x) heat treatment of the dairy emulsion obtained in step (w) at a temperature of 72-99° C. for 2-10 min;
(y) cooling down of the dairy emulsion of (x) to a temperature of 30-45° C.; and
(z) fermentation of the cooled dairy emulsion obtained in step (y).

In a preferred embodiment of the method of the invention, the dairy starting material is preheated at a temperature of 75-85° C.

In a preferred embodiment of the method of the invention, the heat treatment of the dairy emulsion obtained in step (w) is carried out at a temperature of 85-95° C. for 5-6 minutes.

In a preferred embodiment of the method of the invention, the dairy emulsion obtained in (x) is cooled to a temperature of 40-42° C.

Therefore, in a most preferred embodiment, the method of the invention comprises the steps of:
(v) pre-heating the dairy starting material at a temperature of 75° C.;
(w) high pressure homogenization of the pre-heated material obtained in (v) in a single step at a pressure of 300 MPa;
(x) heat treatment of the dairy emulsion obtained in step (w) at a temperature of 90° C. for 5 minutes;
(y) cooling down of the dairy emulsion of (x) to a temperature of 40° C.; and
(z) fermentation of the cooled dairy emulsion obtained in step (y).

In a particular embodiment of the method of the invention, the fermentation step ((e) of process A, (z) of process B, (e/z)) comprises the steps of:
(e/z-1) addition of a starter to the cooled dairy emulsion of (d/y); and
(e/z-2) fermentation of the mixture obtained in step (e/z-1).

The starter to be used in the method of the invention can be any appropriate starter of the art, typically lactic acid bacteria and/or probiotics, such as Lactobacillus delbrueckii subsp. bulgaricus, Streptococcus thermophilus, and others and mixtures thereof. Lactic acid bacteria are known by the one skilled in the art. Probiotics are also known by the one skilled in the art. Examples of probiotics include some Bifidobacteria and Lactobacilli, such as Bifidobacterium brevis, Lactobacillus acidophilus, Lactobacillus casei, Bifidobacterium animalis, Bifidobacterium animalis lactis, Bifidobacterium infantis, Bifidobacterium longum, Lactobacillus casei paracasei, Lactobacillus reuteri, Lactobacillus plantarum, Lactobacillus rhamnosus.

The fermentation can be carried out in fermentation tanks prior filling the final packages or in the final packages. Fermentation is typically performed to a pH allowing the product to set in a substantially gelled form. Fermentation in the final package lead to set products as the gel is not broken.

After fermentation in fermentation tanks, the product optionally is further stirred or pumped by soft agitation, usually at 5-30 r.p.m. in order to break of the formed gel to provide a stirred spoonable or drinkable product.

After that, the final product is usually cooled and stored refrigerated (2-8° C., preferably at 4° C.).

The method of the invention leads to a significant modification of emulsion properties and to an improvement of texture (viscosity and elasticity) of fermented dairy product for given formulations:

As previously stated, the total quantity of fats (coming exclusively from the dairy starting material) in the emulsion may lie in the range of 0.05 to 10% by weight, more particularly, for “skimmed” and “low fat” products in the range of 0.05-2% by weight and for “full-fat” products in the range of 3-5% by weight.

The total quantity of proteins (coming exclusively from the dairy starting material) in the emulsion may lie between 3.0 and 6 wt % by weight, more particularly, for “skimmed” and “low fat” products, in the range of 4-5% by weight, and for “full-fat” products, in the range of 3-4% by weight.

In other aspect, the invention provides a fermented dairy product obtainable by the method of the invention previously disclosed.

The final fermented dairy product can be a full-fat fermented dairy product that comprises 3-4% by weight of fat and 3-4% by weight of protein.

Also, the final fermented dairy product can be a skimmed fermented dairy product that comprises 0.05-2% by weight of fat and 4-4.5% by weight of protein.

Both full-fat and skimmed fermented dairy products obtainable by the method of the invention have an average particle size of less than 400 nm. In a particular embodiment, the fermented dairy product has an average particle size of 100-375 nm. In a preferred embodiment, the fermented dairy product has an average particle size of 250-350 nm.

Additionally, both full-fat and skimmed fermented dairy products have an improved mouth-feel and viscosity, better than those of conventional treated products at same composition, that confer them an improved texture. More in particular, the fermented dairy products of the invention show a viscous modulus of about 70% more in full-fat products (and up to 80% more in set yogurts) and more than 34% in skimmed products (up to 70% in set yogurts), compared to those obtained by conventional pressure homogenization.

The final fermented dairy product obtainable by the method of the invention can be a yogurt, particularly a set yogurt, a stirred yogurt or a drinkable yogurt. The following examples illustrate the invention and should not be considered as limiting its scope of application.

### Example 1

### Preparation of a Full-Fat Yogurt

A set yogurt was prepared by the method of the invention (see FIG. 1a) using a pilot-scale process and compared with a conventional set yogurt, in order to evaluate the efficiency of the process to obtain sensorially improved set-yogurt products.

Fresh raw milk was obtained locally in a liquid form the day of the treatment. The dairy starting material for set yogurts in this Example consisted of raw cow's milk (naturally containing 3.5% by weight of fat) and skimmed milk powder added in order to standardize milk protein content up to 3.9% by weight. The skimmed milk powder was added to raw milk's tank approximately 1 hour before pasteurization, in order to assure complete re-hydration of the powder.

A bulk of standardized raw milk was high pressure homogenized at 300 MPa as control treatment (T1). Another bulk of standardized milk was pasteurized at 90° C. for 5 minutes and immediately cooled down up to 40° C. Milk was divided into two parts, one was subjected to a standard homogenization at 15 MPa (T2) and the other one was subjected to a high pressure homogenization (HPH) treatment at 150 and/or 300 MPa (T3). The high pressure homogenization of the pasteurized milk at 40° C. took place in a B.E.E.-International Micro DeBEE homogenizer at 300 MPa and in a EKATO Nanomix at 150 MPa. Standard homogenization took place in a conventional homogenizer at 15 MPa.

After homogenization, the emulsion was cooled again at 40° C. and yogurt starters (Lactobacillus delbrueckii subsp. bulgaricus and Streptococcus thermophilus) were added. Fermentation took place at 40° C. until the pH of the product reached a value of 4.6. After fermentation, the set yogurt obtained was stored at 4° C. Also, a stirred yogurt was obtained by soft agitation of the set yogurt at 5-30 r.p.m.

Moreover, after each treatment of milk, 500 ml of milk (T1, T2 and T3) were kept separately in order to carry out the particle size, surface tension tests, flocculation measurements and evolution of complex viscosity during fermentation.

In order to establish changes occurring after milk treatments and during the fermentation process, the following assays were performed.

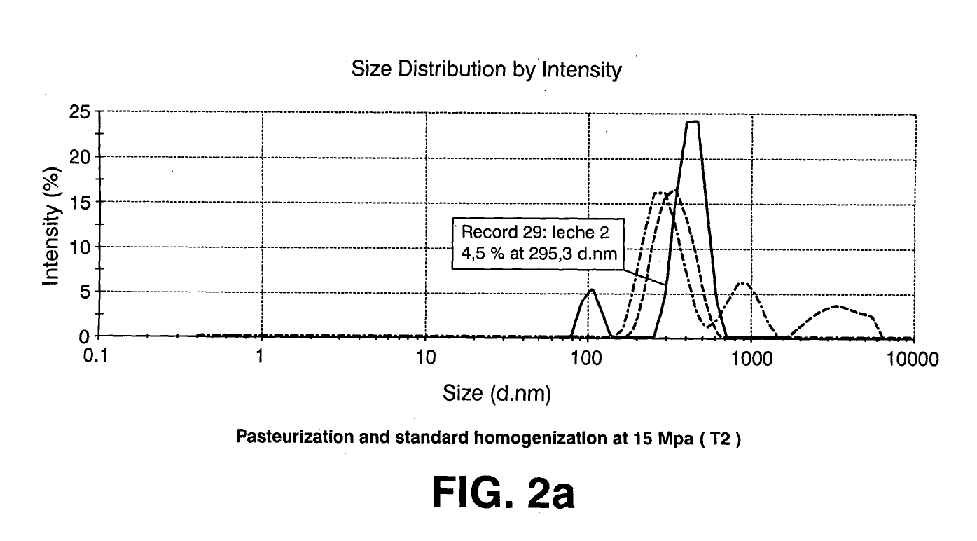

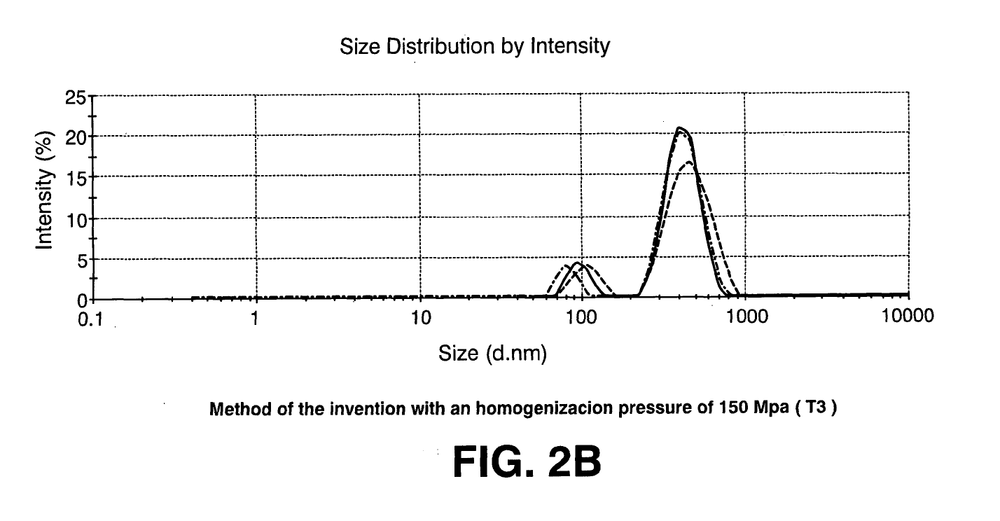

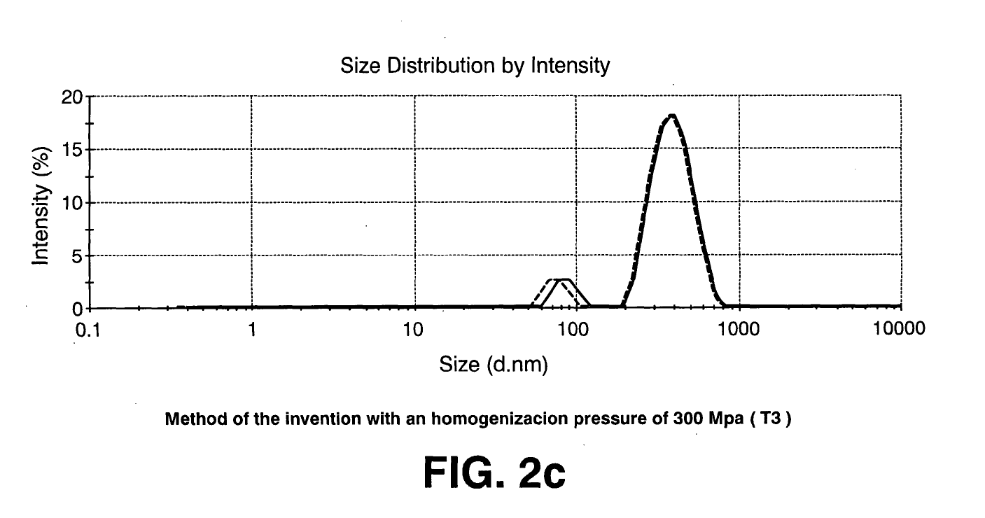

Milk fat globule diameter was determined on treated milk samples using a commercial dynamic light scattering instrument (Zetasizer Nano S, Marlvern Instruments, Worcestershire, UK). The results are showed in FIG. 2.

FIG. 2 shows the distribution of milk fat globules after a pasteurization and standard homogenization method (2a) and after the method of the invention with the homogenization step performed at 150 MPa (2b) and 300 MPa (2c). As can be seen from this FIG. 2, for a milk formulation of 3.5% by weight of fat and 3.9% by weight of proteins, the effect of the method of the invention with respect to the conventional homogenization method is clear: particles have an average particle size of less than 400 nm for pressures of 150 and 300 MPa (327 and 308 nm, respectively) versus an average particle size of 880 nm. Also a more homogeneous distribution of the particle size is obtained.

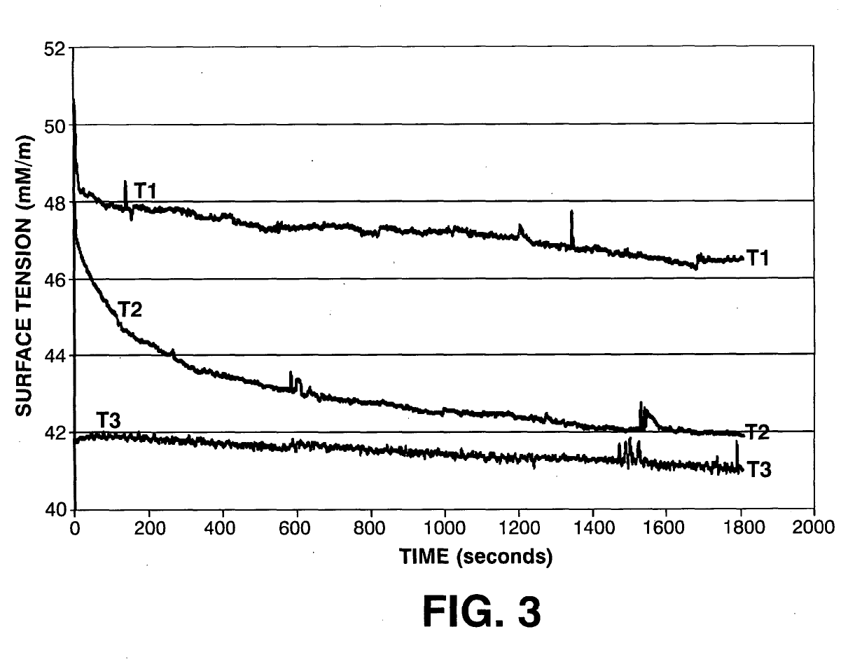

Surface tensions at the air-water interface of treated milk samples were measured by using an FTA200 pulsating drop tensiometer (First Ten Angstroms, USA). The capillary drop was formed with a tip of a syringe of 0.914 mm within an environmental chamber at room temperature, in which standing water increased the relative humidity to minimize drying effects. When required, changes in γ (surface tension) were monitored with a 1^{-s} resolution. All measurements were made at room temperature (≈20° C.). Surface tension was monitored at room temperature for 30 min. The results are showed in FIG. 3.

FIG. 3 is a graph plotting the surface tension of milk proteins treated by high pressure homogenization at 300 MPa (T1), by pasteurization and conventional homogenization at 15 MPa (T2) and treated by the method of the invention at 300 MPa (T3). As can be seen in this FIG. 3, for a formulation of 3.5% by weight of fat and 3.9% by weight of proteins, it is clear that the method of the invention (T3) modifies the milk proteins in a very different way than those modifications caused by a heat treatment and conventional homogenization method (T2) and by a high pressure homogenization method (T1) by themselves. Viewing these results, the combined effect of a thermal and a high pressure homogenization treatment causes an increase in the hydrophobicity of milk proteins.

Gelling during fermentation of milk emulsion is caused by the casein lattice, by proteins aggregating. Processing milk under the above-mentioned conditions of the method of the invention makes it possible with all formulations to produce emulsions that are finer (fat globules under 400 nm of diameter) but also with altered flocculation and superficial tension properties of the proteins. This point is of great importance since even reducing the mean size of the particles is a desirable aim, even is more important to modify the protein properties because they are the wetting particles needed in order to stabilize the new water/oil interfaces that are created.

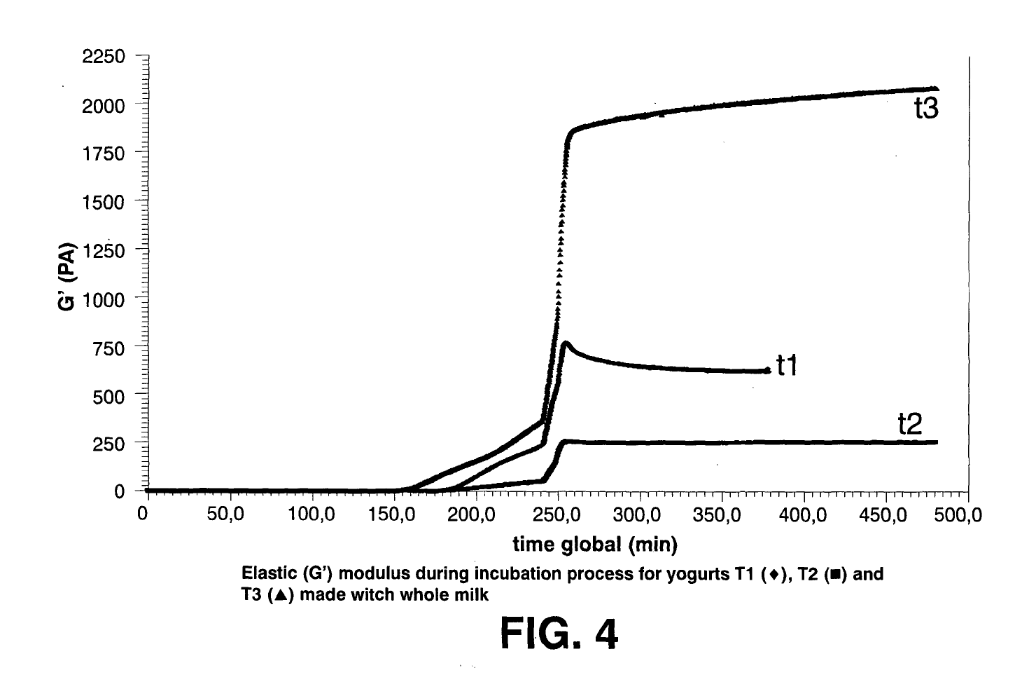

For the measurement of the rheological properties during the formation of the yogurt, a stress-controlled rheometer AR2000 (TA Instruments, United Kingdom) was used with a concentric cylinder (15 mm inner radius and 42 mm height). Milk at 40° C. was inoculated with the starter culture (Lactobacillus delbrueckii subsp. bulgaricus and Streptococcus thermophilus). After inoculation, 20 ml of this milk were poured into the rheometer vessel and were maintained at 40° C. for 4 hours (in order to let the product reach a pH value of 4.6). After incubation at 40° C., temperature was diminished at 4° C. and maintained for 4 h more. During the whole measurement time, an oscillatory test was applied by using 0.5% strain and 1 Hz of frequency. The results are showed in FIG. 4.

FIG. 4 is a graph plotting the evolution of elasticity (G′) during the fermentation step after a high pressure homogenization method at 300 MPa (T1), after a pasteurization and conventional homogenization method at 15 MPa (T2) and after the method of the invention at 300 MPa (T3). In this FIG. 4 higher G′ values correspond to a firmer yogurt.

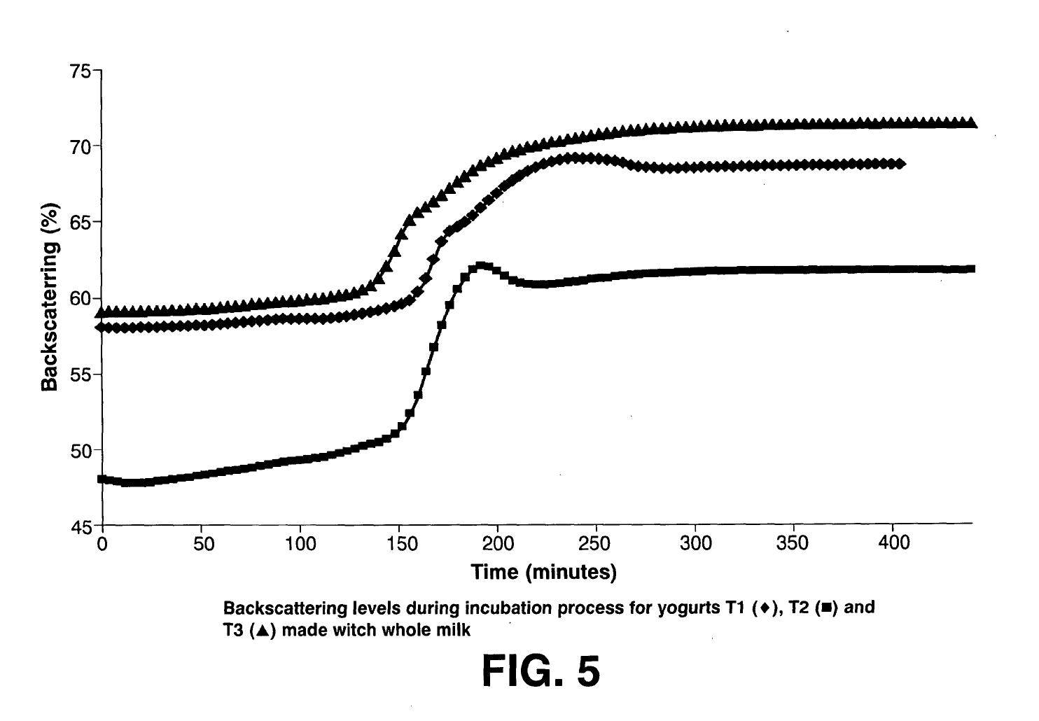

For floculation levels measurement during the formation of the yogurt, a Turbiscan Labexpert (Formulaction, France) was used. This technology consists in measuring the backscattering and transmission intensities versus the sample height in order to detect particle size change (coalescence, flocculation) and phase separation (sedimentation, creaming). Inoculated milk was introduced in the instrument at 40° C. for 4 h. After this incubation, temperature was diminished to 9.5° C. and maintained for 4 hours more. Backscattering light was recorded by scanning the sample tube every 4 minutes in order to detect flocculation level in milk during the yogurt network formation. The results are showed in FIG. 5.

FIG. 5 is a graph plotting flocculation measurements during fermentation step for the emulsion from a high pressure homogenization method at 300 MPa (T1), from a pasteurization and conventional homogenization method at 15 MPa (T2), and from the method of the invention (T3). In FIG. 5, higher backscattering values correspond to a closer and stronger net, that is, to a firmer yogurt.

Therefore it is found that the fermenting, floculating and gelling rate of the treated milk also changes (FIGS. 4-5), which shows that the method of the invention (T3) has more effect on its reaction and viscoelastic structure.

Thus, in conclusion, the effect of the temperature during the whole process of the invention (the pasteurization and the heating effect due to the high pressure homogenization) and the strong shear and shocks occurring in the chamber of high pressure homogenizer induce changes not only in fat globules size, but also in conformation of proteins. While fermentation, proteins from emulsion treated according to the method of the invention, form a closer lattice, as demonstrated, thus giving an unexpected firmer texture and a more stable gel.

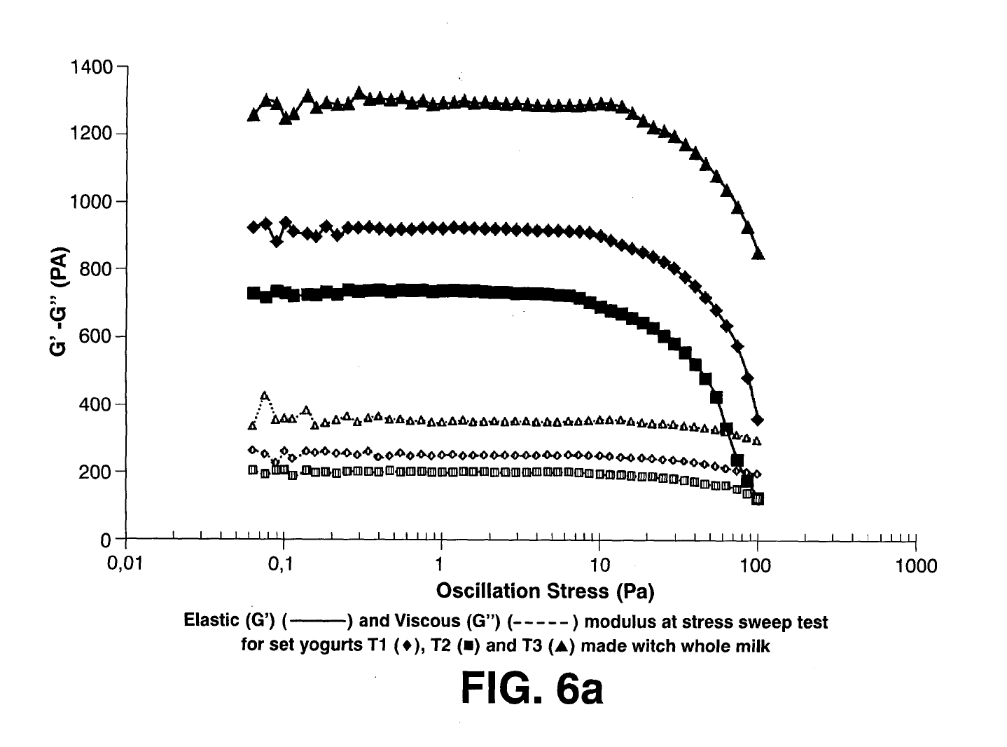

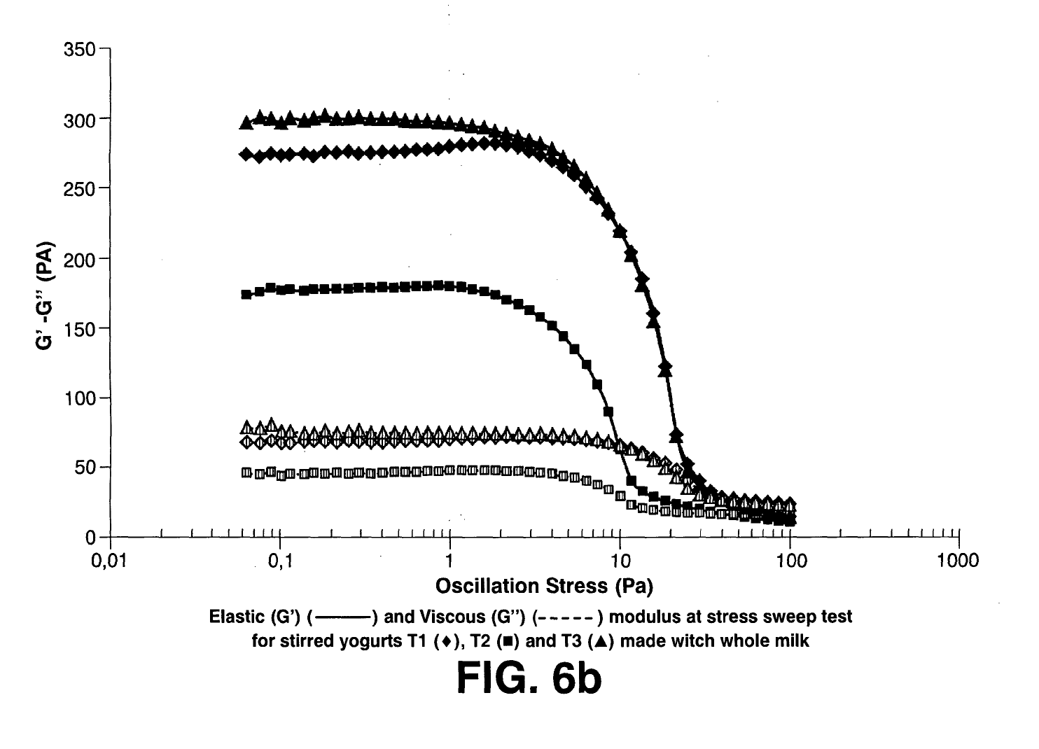

For the viscoelastic properties characterization of the final product (set and stirred yogurts) a stress-controlled rheometer AR2000 (TA Instruments, United Kingdom) was used by using a geometry hatched parallel plate of 20 mm diameter (to avoid slippery). Measurements were carried out in an oscillatory mode 1) using a stress sweep test (from 0.063 to 100 Pa) at 1 Hz frequency and 2) using a frequency sweep from 0.01 to 10 Hz with a applied stress of 0.4 Pa (within the linear viscoelastic region). All the measurements were carried out at 7° C. The results are showed in Table 1 and in FIG. 6a and FIG. 6b.

TABLE 1
Stress Sweep Values obtained at 1 Pa, 1 Hz, 7° C.: G′elastic modulus; G″
viscous modulus; η* complex viscosity; tg(δ) and γ deformation.

| | G′ | | G″ | | η* | | | | | |
|---|---|---|---|---|---|---|---|---|---|---|
| | (Pa) | | (Pa) | | (Pa · s) | | tg (δ) (—) | | γ (—) | |
| | Mean | Std | Mean | Std | Mean | Std | Mean | Std | Mean | Std |
| T1 | 931 | 51 | 252 | 12 | 154 | 8 | 0.2703 | 0.0019 | 15.13 | 0.10 |
| set yogurt | | | | | | | | | | |
| T2 | 711 | 50 | 193 | 13 | 117 | 8 | 0.2720 | 0.0015 | 15.21 | 0.08 |
| set yogurt | | | | | | | | | | |
| T3 | 1295 | 1 | 352 | 4 | 214 | 0 | 0.2347 | 0.0490 | 15.21 | 0.19 |
| set yogurt | | | | | | | | | | |
| T1 stirred | 267 | 20 | 67 | 5 | 44 | 3 | 0.2518 | 0.0016 | 14.17 | 0.08 |
| yogurt | | | | | | | | | | |
| T2 stirred | 174 | 14 | 46 | 3 | 29 | 2 | 0.2663 | 0.0043 | 14.97 | 0.23 |
| yogurt | | | | | | | | | | |
| T3 stirred | 317 | 68 | 80 | 17 | 52 | 11 | 0.2534 | 0.0027 | 14.22 | 0.14 |
| yogurt | | | | | | | | | | |

FIG. 6a is a graph plotting curves of viscosity (G″) and elasticity (G′) of a set full-fat yogurt (3.9% protein and 3.5% fat) obtained after a high pressure homogenization method at 300 MPa (T1), after a pasteurization and conventional homogenization method at 15 MPa (T2) and after the method of the invention at 300 MPa (T3).

FIG. 6b is a graph plotting curves of viscosity (G″) and elasticity (G′) of a stirred full-fat yogurt (3.9% protein and 3.5% fat) obtained after a high pressure homogenization method at 300 MPa (T1), after a pasteurization and conventional homogenization method at 15 MPa (T2) and after the method of the invention at 300 MPa (T3).

Levels of viscosity obtained with the method of the invention, (T3) are significantly higher than the treatment usually studied to improve yogurt texture, a one-step high pressure homogenization (T1). It confirms that the method of the invention (T3) is able to hardly change the structure of milk proteins and fat, to reach to a higher improvement in texture.

In fact, the full-fat yogurt obtained by the method of the invention has a texture similar to that of “Greek yogurt” but with a lower content of fat.

To confirm consumer appreciation of the yogurts obtained by the method of the invention, a sensory analysis was carried out with a panel of 20 consumers, using UNE.ISO 4121:2006 for sensory valorisation by means of quantitative response scales. In most cases, consumers highlighted the creamy, thick and homogeneous texture, with less clot assessment in visual evaluation, and a good milk/dairy aroma.

### Example 2

### Preparation of a Skimmed Yogurt

A skimmed set yogurt was prepared by the method of the invention (see FIG. 1a) using a pilot-scale process and compared with a conventional skimmed set yogurt, in order to evaluate the efficiency of the process to obtain improved mouth-feel set-yogurts.

Fresh raw milk was obtained locally in a liquid form the day of the treatment. In a first step, raw milk was de-creamed, and immediately used in the process of yogurt manufacturing. The dairy starting material for skimmed set yogurts in this Example consisted of the skimmed untreated cow's milk (approximately 0.05% fat) and skimmed milk powder added in order to standardize milk protein content up to 4.5% by weight. Skimmed milk powder was added to skimmed milk's tank approximately 1 hour before pasteurization, in order to assure complete re-hydration of the powder.

A bulk of standardized skimmed milk was high pressure homogenized at 300 MPa as control treatment (T1). Another bulk of standardized milk was pasteurized at 90° C. for 5 minutes and immediately cooled down up to 40° C. Milk was divided into two parts, one was subjected to an standard homogenization at 15 MPa (T2) and the other one was subjected to a high pressure homogenization (HPH) treatment at 300 MPa (T3). The high pressure homogenization of the pasteurized milk at 40° C. took place in a B.E.E.-International Micro DeBEE homogenizer at 300 MPa. Standard homogenization took place in a conventional homogenizer at 15 MPa.

After homogenization, the emulsion was cooled again at 40° C. and yogurt starters (Lactobacillus delbrueckii subsp. bulgaricus and Streptococcus thermophilus) were added. Fermentation took at 40° C. until the pH of the product reached a value of 4.6. After fermentation, the set skimmed yogurt obtained was stored at 4° C. Also, a stirred yogurt was obtained by soft agitation of the set yogurt at 5-30 r.p.m.

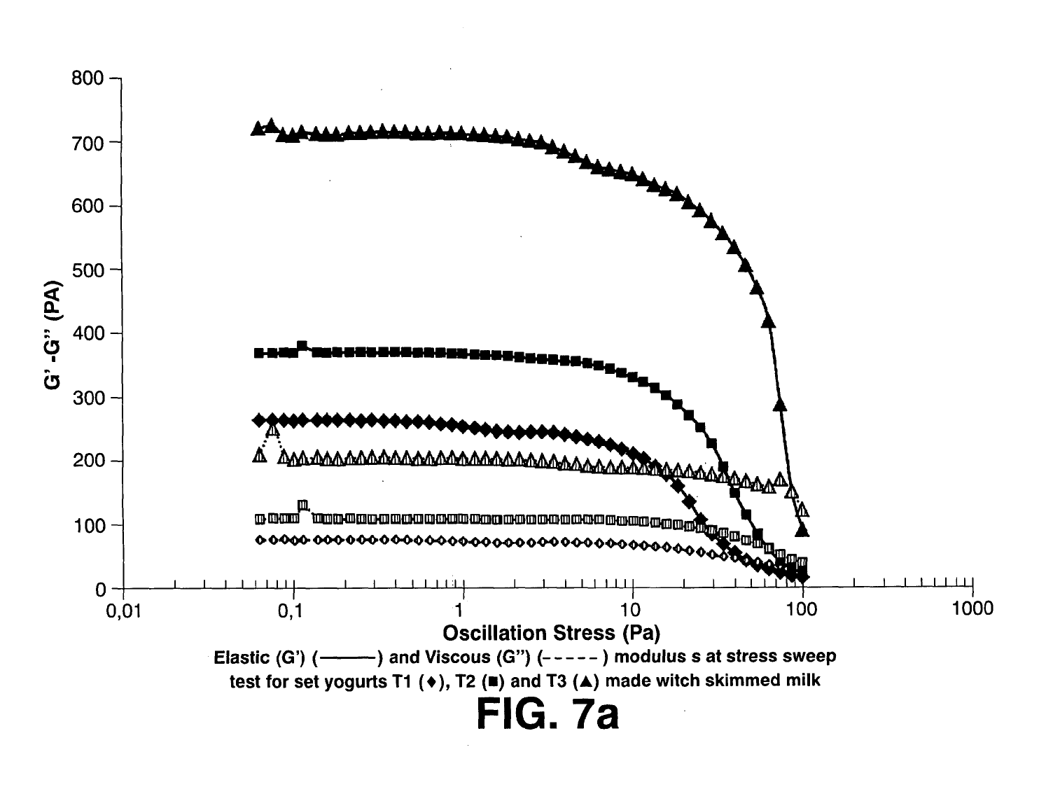

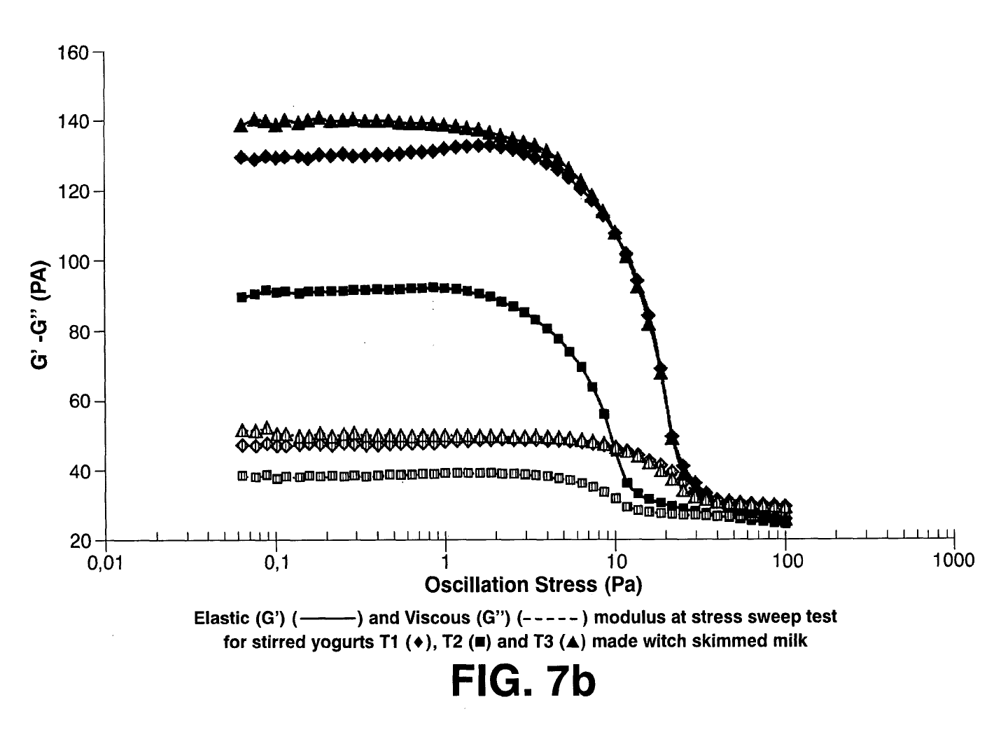

Rheological analyses of the skimmed yogurts were performed as in Example 1 in order to assess its viscoelastic properties. Results are shown in Table 2 and FIG. 7a and FIG. 7b.

TABLE 2
Stress Sweep Values obtained at 1 Pa, 1 Hz, 7° C.: G′elastic modulus; G″
viscous modulus; η* complex viscosity; tg(δ) and γ deformation.

| | G′ | | | | η* | | | | | |
|---|---|---|---|---|---|---|---|---|---|---|
| | (Pa) | | G″(Pa) | | (Pa · s) | | tg (δ) (—) | | γ (—) | |
| | Mean | Std | Mean | Std | Mean | Std | Mean | Std | Mean | Std |
| T1 | 241 | 22 | 70 | 5 | 40 | 4 | 0.292 | 0.0084 | 16.28 | 0.45 |
| set yogurt | | | | | | | | | | |
| T2 | 374 | 64 | 110 | 18 | 62 | 11 | 0.2956 | 0.0029 | 16.43 | 0.14 |
| set yogurt | | | | | | | | | | |
| T2 | 663 | 98 | 191 | 27 | 110 | 16 | 0.2875 | 0.0021 | 16.04 | 0.11 |
| set yogurt | | | | | | | | | | |
| T1 stirred | 45 | 8 | 16 | 3 | 8 | 1 | 0.3419 | 0.0021 | 18.86 | 0.12 |
| yogurt | | | | | | | | | | |
| T2 stirred | 95 | 5 | 29 | 2 | 16 | 1 | 0.3029 | 0.0006 | 16.85 | 0.03 |
| yogurt | | | | | | | | | | |
| T2 stirred | 141 | 8 | 39 | 2 | 23 | 1 | 0.2763 | 0.0036 | 15.45 | 0.19 |
| yogurt | | | | | | | | | | |

FIG. 7a is a graph plotting curves of viscosity (G″) and elasticity (G′) of a set skimmed yogurt (0.05% fat and 4.5% protein) obtained after a high pressure homogenization method at 300 MPa (T1), after a pasteurization and conventional homogenization method at 15 MPa (T2) and after the method of the invention at 300 MPa (T3).

FIG. 7b is a graph plotting curves of viscosity (G″) and elasticity (G′) of a stirred skimmed yogurt (0.05% fat and 4.5% protein) obtained after a high pressure homogenization method at 300 MPa (T1), after a pasteurization and conventional homogenization method at 15 MPa (T2) and after the method of the invention at 300 MPa (T3).

Levels of viscosity obtained with the method of the invention, (T3) are significantly higher than the treatment usually studied to improve yogurt texture, a one-step high pressure homogenization (T1). It confirms that the method of the invention (T3) is able to hardly change the structure of milk proteins and fat, to reach to a higher improvement in texture.

In fact, the skimmed yogurt obtained by the method of the invention shows a better texture than conventional skimmed yogurts but with no addition of usual additives such as thickeners or stabilizers.

1. A method for obtaining a fermented dairy product characterized by a heat treatment step followed or preceded by a high pressure homogenization step at a pressure above 100 MPa and up to 350 MPa of a dairy starting material, wherein the total fat composition of the dairy starting material lies between 0.05% and 10% by weight, wherein the total quantity of protein lies between 3 and 10% by weight, and wherein the fat and protein come exclusively from the dairy starting material.

2. Method according to claim 1 characterized in that it comprises the steps of:
(a) heat treatment of a dairy starting material at a temperature of 72-99° C. for 2-10 minutes;
(b) optionally cooling down of the heated material obtained in (a) to a temperature lower that the temperature of (a) and in the range of 40-98° C.;
(c) high pressure homogenization of the material obtained in (a) or optionally in (b) in a single step at a pressure of 100-350 MPa to obtain a dairy emulsion;
(d) cooling down of the dairy emulsion obtained in (c) to a temperature of 30-45° C.; and
(e) fermentation of the cooled dairy emulsion obtained in step (d).

3. Method according to claim 1 characterized in that it comprises the steps of:
(v) pre-heating the dairy starting material at a temperature of 40-99° C.;
(w) high pressure homogenization of the pre-heated material obtained in (v) in a single step at a pressure of 100-350 MPa;
(x) heat treatment of the dairy emulsion obtained in step (w) at a temperature of 72-99° C.
(y) cooling down of the dairy emulsion of (x) to a temperature of 30-45° C.; and
(z) fermentation of the cooled dairy emulsion obtained in step (y).

4. Method according to claim 1, characterized in that the pressure applied in high pressure homogenization step is greater than 130 MPa and less than 330 MPa.

5. Method according to claim 1, characterized in that the pressure applied in high pressure homogenization step is greater than 200 MPa and less than 310 MPa.

6. Method according to claim 1, characterized in that the fermentation step (e/z) further comprises the steps of:
(e/z-1) addition of a starter to the cooled dairy emulsion of (d/y); and
(e/z-2) fermentation of the mixture obtained in step (e/z-1).

7. Method according to claim 1, characterized in that the dairy starting material consists of milk, a milk derivative or mixtures thereof.

8. Method according to claim 7, characterized in that the milk is selected from raw milk, skimmed milk, semi-skimmed milk, fat-enriched milk, and mixtures thereof.

9. Method according to claim 7, characterized in that the milk derivative is selected from milk powder, skimmed milk powder, milk proteins, milk protein concentrate, concentrated milk, evaporated milk, milk cream, and mixtures thereof.

10. Method according to claim 7, characterized in that the dairy starting material consists of a mixture of raw milk and skimmed milk powder.

11. Method according to claim 7, characterized in that the dairy starting material consists of a mixture of skimmed milk and skimmed milk powder.

12. Fermented dairy product obtainable by the method of claim 1, characterized in that it comprises 3-4% by weight of fat and 3-4% by weight of protein and an average particle size of less than 400 nm.

13. Fermented skimmed dairy product obtainable by the method of claim 1, characterized in that it comprises 0.05-2% by weight of fat and 4-4.5% by weight of protein and an average particle size of less than 400 nm.
